(19) United States
(12) Patent Application Publication
(10) Pub. No.: US 2016/0350685 A1
(43) Pub. Date: Dec. 1, 2016

(54) INTERACTION SUPPORT PROCESSOR

(71) Applicant: Dirk HELBING, Zurich (CH)

(72) Inventor: Dirk Helbing, Zurich (CH)

(21) Appl. No.: 15/116,772

(22) PCT Filed: Feb. 4, 2015
(86) PCT No.: PCT/IB2015/050830

§ 371 Date: Aug. 4, 2016

Related U.S. Application Data
(60) Provisional application No. 61/935,719, filed on Feb. 4, 2014.

(51) Int. Cl. G06Q 10/06

(52) U.S. Cl. CPC G06Q 10/0637

(57) ABSTRACT

Disclosed are various embodiments for creating technological systems and methods to support favorable kinds of interactions in techno-socio-economic-environmental systems by determining the value of interactions between components of a system, raising awareness for value-changing interactions, supporting a more successful execution of value-increasing interactions while avoiding value-decreasing ones, and facilitating value exchange, with the aim of increasing the component and systemic benefits, while protecting sensitive information where needed.

### CROSS-REFERENCES TO PRIORITY AND RELATED APPLICATIONS

This application claims priority from and is a non-provisional of U.S. Provisional Patent Application No. 61/935,719 filed Feb. 4, 2014, entitled “SOCIAL INTERACTION SUPPORT PROCESSOR.” The entire disclosures of the application recited above is hereby incorporated by reference, as if set forth in full in this document, for all purposes.

### FIELD OF THE INVENTION

The present disclosure relates generally to techno-socio-economic-environmental systems.

### SUMMARY

Example embodiments of the present invention include systems and methods for supporting favorable kinds of interactions in techno-socio-economic-environmental systems. The following describes and illustrates methods and systems for determining the value of interactions between components of a system, raising awareness for profitable or unfavorable interactions, supporting a more successful execution of such interactions, and facilitating a value transfer, with the aim of increasing the component and systemic benefits, while protecting sensitive information where needed.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is an illustrative example of an environment in accordance with at least one embodiment;

FIG. 2 is an illustrative example of a block diagram in which various embodiments can be implemented;

FIG. 3A is an illustrative example of a section of a block diagram in accordance with at least one embodiment;

FIG. 3B is an illustrative example of a section of a block diagram in accordance with at least one embodiment;

FIG. 3C is an illustrative example of a section of a block diagram in accordance with at least one embodiment;

FIG. 3D is an illustrative example of a section of a block diagram in accordance with at least one embodiment;

FIG. 3E is an illustrative example of a section of a block diagram in accordance with at least one embodiment;

FIG. 4 is an illustrative example of a process for supporting component interactions in accordance with at least one embodiment;

FIG. 5 is an illustrative example of a process for supporting component interactions in accordance with at least one embodiment; and

FIG. 6 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Many multi-component techno-socio-economic-environmental systems, such as the World Wide Web or financial systems suffer from harmful instabilities, which lead to systemic malfunctions or other undesirable outcomes and call for new technological solutions in order to provide stability and interoperability.

Example embodiments include technological inventions to support favorable kinds of interactions in techno-socio-economic-environmental systems. Example embodiments serve to make the occurrence of systemic instabilities and failures in complex techno-socio-economic-environmental systems, or systems influenced by autonomous or semi-autonomous actors, less likely, e.g., by modifying or avoiding interactions between system components or by changing “win-lose situations” into “win-win situations.”

In various embodiments, the system can be implemented as algorithms, applications, modules, or the like configured on a user device operably interconnected with a server apparatus via a network, such as the Internet. In the instant example embodiment, the user device is configured to run a client for initiating communication with the server via the Internet. The client or user could also be a human user, an autonomously deciding computational device, etc. interacting with the server via the Internet.

The server can be implemented in a hardware apparatus, for example, a computer or computational system, or can be implemented as a software application running on the computer or computer system. In alternative example embodiments, one or more clients may be operably interconnected to one or more servers or clusters via a network or intermediary networks and may similarly communicate with other destination devices coupled to the network or intermediary networks.

The user devices can include a desktop personal computer, workstation, laptop, personal digital assistant (PDA), cell phone, or any WAP-enabled device or any other computational device capable of interfacing directly or indirectly to the Internet or other databases, including cloud storage or peer-to-peer systems. The client may run a network interface application or software application, which can, for example, be a browsing program to enable users to locate and access information provided by a server. Such a server can be a web server where the browsing application is primarily configured for use of the World Wide Web, but could also access information in private networks or files in file systems. The client could also run a WAP-enabled browser executing on a cell phone, PDA, other wireless device or the like. The network interface application can allow a user or a client to access, process and view information and documents available to it.

An alternative embodiment is based on replacing client-server systems by peer-to-peer (p2p) or other decentralized information and communication systems.

A user can control (e.g., via user input and/or automated instructions) a client to send a request message to a server with a request for a specific resource, content, information or the like using HTTP or any other communication protocols. The request messages are electronic request messages submitted over the Internet or other information systems via web clients and are provided to the server (or alternative information systems such as p2p systems) for processing. The server can be configured to process a request in many ways and respond to the request, for example, by providing the content of the resource or a message disclosing an error or other action if the server will not or is not able to provide the content. The request messages may be electronic request messages submitted over the Internet via a web client, and may be provided to the server for processing. The server may be configured to process a request and respond to the request, for example, by providing a markup document, such as a structured document or HyperText Markup Language (HTML) document. The server may respond to the users via their respective web clients in the same or different manner. Other embodiments may include a request being a request for network resources, for example, a request for a website, webpage, client application, mobile application or other resources currently known or hereafter developed.

Techniques described and suggested herein include systems, methods, and computer-readable media for simulating simplified models of societal, economical, technological, environmental, their interdependencies, and other relevant activities in an interactive environment. The embodiments are configured to model real world or virtual interactions between two or more components of a system (referred to herein as system components or components) under close-to-realistic conditions in order to improve, modify, adapt, and/or advise on the modeled interactions. Example embodiments of the present disclosure provide for an interactive platform receiving various inputs in order to generate (probabilistic) predictive information to generate feedbacks supporting components of a system in producing a beneficial, valuable outcome. A component of a system may be any type of user, human or automated (e.g., software applications), artificial intelligence, learning machines, or algorithms that interacts for some economic, social, technological, environmental, or other activity, or a combination thereof. The system provides for social information and communication technologies that are adaptive, interactive, and supportive in order to create affective interactions according to the socio-techno-economic-environmental systems and their components. Example embodiments further serve to improve interoperability of system components.

The instant disclosure improves upon such existing models by incorporating behavioral and social information based on any number of components at play in the system engaged in goal- or outcome-directed behaviors, where behaviors could also mean the state of an algorithm, automated-agent, artificial intelligence, etc. Example embodiments include a behavioral mirror engine to compare public and personal data, a behavioral adapter engine configured to share selected information with selected components of a system to support decisions of the components of the system, a collective protector engine configured to advise components of the system of potentially lossful interactions and to mobilize social support, and a value exchange engine configured to advise in value transfers and transactions using monies.

These engines are operably interconnected that may be configured in one or more servers of a computational system configured to receive information from any number of inputs, such as user devices, computers, information exchange systems, automated-agents (e.g., software applications, daemons, etc.), and other computing devices configured for transmitting, receiving, and/or processing data.

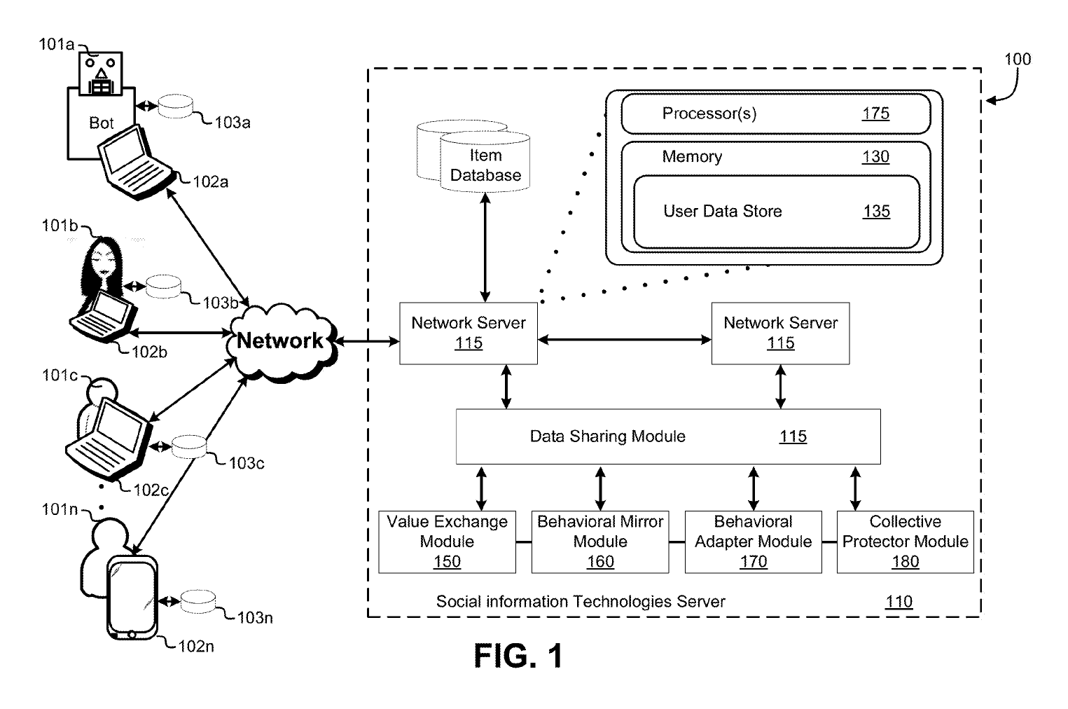

FIG. 1 is an example embodiment of an environment 100 for implementing aspects in accordance with various embodiments. As will be appreciated, although an Internet environment 100 is used for purposes of explanation, different environments may be used, as appropriate, to implement various embodiments.

FIG. 1 is an example embodiment of an environment 100 for implementing aspects in accordance with various embodiments. As will be appreciated, although a virtual desktop service environment is used for purposes of explanation, different environments may be used, as appropriate, to implement various embodiments.

In the environment 100, a Social Information Technologies server 110 provides various computing resource services to customers, components, or users of the Social Information Technology server or system. Users 101a-101n, via respective user devices 102a-n, may connect with one another or with other components of one or more systems via the network 105. The user devices 102a-n may be operably interconnected to decentralized storage 103a-103n, which can include storing personal or other sensitive or confidential data decentrally in order to reduce the potential for a misuse of data.

Example embodiments include technological inventions to support favorable kinds of interactions in techno-socio-economic-environmental systems. Example embodiments serve to make the occurrence of systemic instabilities and failures in complex techno-socio-economic-environmental systems—or systems influenced by autonomous or semi-autonomous actors—less likely, e.g., by modifying or avoiding interactions between system components or by changing “win-lose situations” into “win-win situations.”

Example embodiments of the present invention include tools, systems and mechanisms to support situational/context awareness, to facilitate profitable interactions, to avoid lossful interactions, to create incentives for systemically favorable kinds of interactions and to support a value transfer or other feedback, referred to herein as Social Information Technologies. Portions of the Social Information Technology disclosed herein are referred to as the Behavioral Mirror, the Behavioral Adapter, the Collective Protector, the Reputation Money, the User-Controlled Reputation System, and Value Exchange System, and are further described and defined in detail throughout this disclosure.

Further example embodiments can include a “Behavioral Mirror” as provided by the Behavioral Mirror Module 160, which can, for example, compare public and personal data and use reputation data and valuation processes to give a feedback on the situation of a user in a particular context.

Another example embodiment includes a “Behavioral Adapter” as provided by the Behavioral Adapter Module 170, which can be used to share selected information with selected others to support the decisions of a user and bargain a value exchange.

Further example embodiments include a “Collective Protector” as provided by the Collective Protector Module 180, which can be used to warn a user of potentially lossful interactions and mobilize support in case there is a danger to encounter a loss.

The behavioral mirror module 160, behavioral adaptor module 170, and collective protector module 180 may be operably interconnected with a data-sharing module 145 (explained in detail below) in order to transmit and receive data from the users 101a-101n via the network 105. Data may be stored at the network server 115 and transmitted to the modules depending upon user permissions, for example. Furthermore, information determined by the Social Information Technologies server 110 may be transmitted back to the users via a feedback engine 149. Information feedback can be transmitted from the feedback engine 149 and can include information that is provided to the user in an easily understandable form (e.g., by whispering advice into an ear or by using augmented reality approaches). The network server 115 may further be operably interconnected with a processor 175, a memory 130, and a user data store 135, and further operably connected to one or more databases 120.

The undesirable outcomes can be caused by interactions of system components, which may be formalized within the framework of the natural science of complex systems and addressed with the engineering science of cybernetics. In case of systemic instabilities, even if all components try to create a more desirable outcome, they may fail to reach such an outcome, as a small variation, perturbation, disturbance, or error can cause a kind of interactions known as “amplification effect” and/or a series of interactions known as “cascade effect”, ending in an undesirable state. An example of a cascade effect is the breakdown of free traffic flow due to interactions between vehicles, resulting in a “phantom traffic jam”—a problem that can be overcome by modifying the vehicle interactions through particular driver assistant systems; further examples, where the desirable behavior is unstable, are conflicts or “tragedies of the commons” (such as environmental degradation, overfishing, or global warming).

In some of the following example embodiments, it is assumed that there exists a “value function” that can be used to quantify how desirable a state is for a component. This function may depend on many variables, for example, on contextual variables such as the states of other components with which a considered component interacts, or on previous states of a component. Example embodiments disclose methods and systems to create a technological system that helps one to determine the value (“success”) of an interaction, to raise awareness for (or create feedback to) profitable or unfavorable interactions, support a more successful execution of such interactions, or support a value transfer, which increases individual and systemic benefits at the same time (i.e., supports win-win situations while avoiding others).

When two components interact, there may be several possible outcomes. A first potential outcome includes a situation where both components have a less favorable (i.e., lower valued) state of operation (referred to as a “lose-lose situation”). A second potential outcome includes a situation where one component has a more favorable (i.e., higher valued) state, but the other component has a less favorable state (referred to as a “win-lose situation” or “conflict (of interest)”). A third potential outcome includes a situation where the states of operation of both components are more desirable (i.e., higher valued) than their previous states of operation (referred to as a “win-win situation”). One skilled in the art should recognize that multiple components can interact with other multiple components, and a multitude of permutations and/or combinations can lead to additional outcomes. The example embodiments refer to two components while it should be understood that an indefinite number of components is similarly imagined according to methods and systems presented herein.

In example embodiments when two components interact, there can be four possible cases (as there are two kinds of win-lose situations—bad win-lose situations or good win-lose situations).

In a lose-lose-situation, the interaction should be better avoided. Awareness of the lose-lose situation will help to avoid such interactions. Segregation or decoupling strategies are some of the possible solutions.

In a bad win-lose situation, if the benefit (i.e., value increase) of an interaction for one component is lower than the disadvantage (value decrease) for the other, such that the overall systemic outcome (typically the sum of the two values) deteriorates, the interaction should be avoided as in the lose-lose situation. However, as one component has a possible advantage of the interaction, measures are needed to protect the other component from losses of value.

In a good win-lose situation, an interaction would be more value-increasing for one component, than value-decreasing for the other. In such a situation, the other component can be compensated for the value decrease by a value transfer, such that the interaction becomes profitable (value-increasing) for both. This may require a bargaining process. Moreover, one component should be protected from exploitation by the other.

In a win-win situation, an interaction would be favorable (value increasing) for both components. In such a case, the interaction should be performed. In addition, a value transfer can be carried out to reach a fairer sharing of profits by the interacting components (i.e., more balanced value increases).

Example embodiments presented herein describe technological inventions to support favorable (value increasing) kinds of interactions and avoid or discourage unfavorable (value decreasing) kinds of interactions. Example embodiments serve to make the occurrence of losses in value, e.g., due to systemic instabilities and failures in complex techno-socio-economic-environmental systems less likely. This can be done, for example, by modifying or avoiding interactions between system components and/or turning win-lose situations into win-win situations.

Example embodiments are configured to align a system component's value-increasing interests with an increase in overall system performance and may apply in a multitude of industries and services, for example, for use in the entertainment industry, for modern web applications, for establishing a basis of a future value exchange system, for information exchange systems, financial or payment systems, etc. and combinations thereof

The components of these systems can be of various kinds, for example, computers, smart phones, banks, companies, human individuals, users, the environment, etc. These system components can have different states of operation, which are referred to as their “state” or “behavior.” Interactions between components can exist, for example, when the state and/or behavior of one component influences the state and/or behavior of another component or several components. Due to the large degree of networking or other interdependencies in techno-socio-economic-environmental systems, interactions between system components are very common.

For the sake of illustration, the principles of the above technologies and example embodiments presented herein are presented with the example of “users” as relevant system components; this is just an example of non-limiting components—other components could include, for example, robots, computers, artificial intelligence, learning machines, or algorithms. Example embodiments of the components interact in a situation- or context-dependent way. Terms like “environment” or “local culture” may be used for the respective “context” of the components, while “social” typically refers to the “networked” nature of the system components and their interactive behaviors under consideration. Application areas include, but are not restricted to, information systems, financial markets, decision support systems, gaming and entertainment.

The following sections will explain the features of the Socially Interactive Technologies in more detail.

### Social Orientedness

Example embodiments disclose “social” (i.e., interactive) and “socially-oriented” (interaction-focused) methods and systems. Social orientedness results from the focus on network interactions of system components and on producing outcomes that are favorable for them, according to their valuation of the (potential) interaction. One goal is to support “other-regarding” interactions that take into account the impact of the behavior of one component on a second component (sometimes called “externalities”). Such “other-regarding” interactions can create better outcomes on the systemic level and for the individual components. To quantify the (possible) value-related impact of interactions, one must perform suitable measurements.

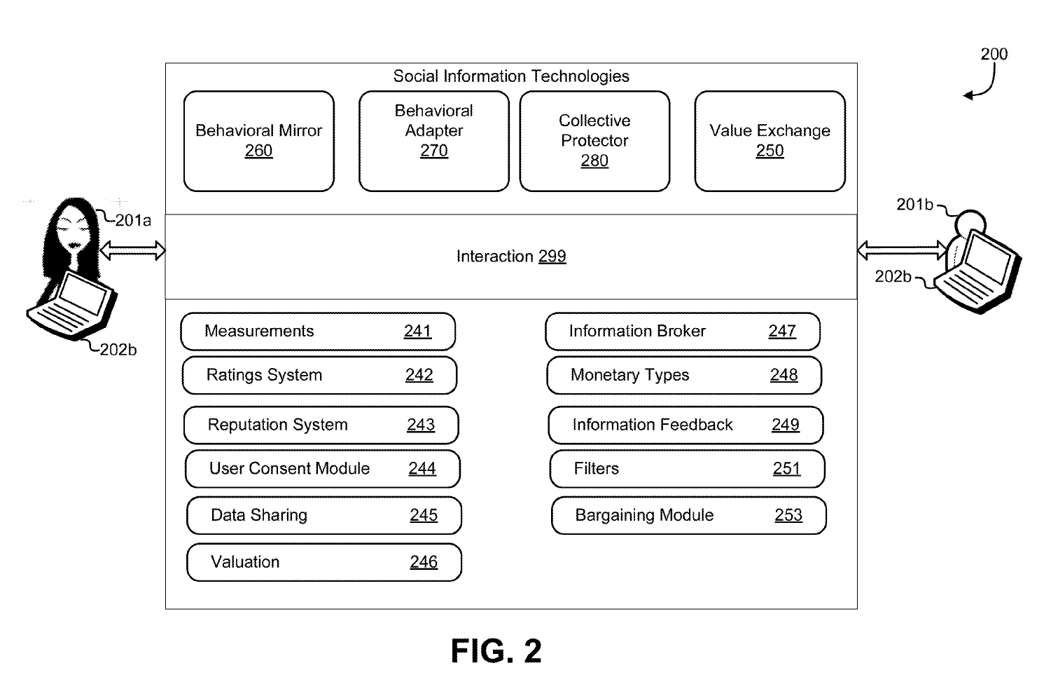

FIG. 2 is an illustrative example of a block diagram illustrating two components of a system using Social Information Technologies to model and/or perform an interaction. A first user 201a operating via a user device 202a is connected with a second user 201b operating via a user device 202b over a network to perform an interaction 299. The Social Information Technologies include a behavioral mirror module 260, behavioral adapter module 270, a collective protector module 280, and a value exchange module 250.

Example embodiments of the present invention further include mechanisms, systems, and/or methods to support situational or contextual awareness (herein referred to as a “Behavioral Mirror” 260), to facilitate profitable interactions (herein referred to as a “Behavioral Adapter” 270), to avoid lossful interactions (herein referred to as a “Collective Protector” 280), and/or to create incentives for systemically favorable kinds of interactions and support a value transfer (herein referred to as “Value Exchange” 250 or “Reputation Money”).

Social Information Technologies are socially inspired or socially oriented and can be applied to many non-human systems with interacting system components. For example, they can support favorable (value-increasing) interactions or help to avoid undesirable (value-decreasing) interactions in artificial or techno-socio-economic-environmental systems.

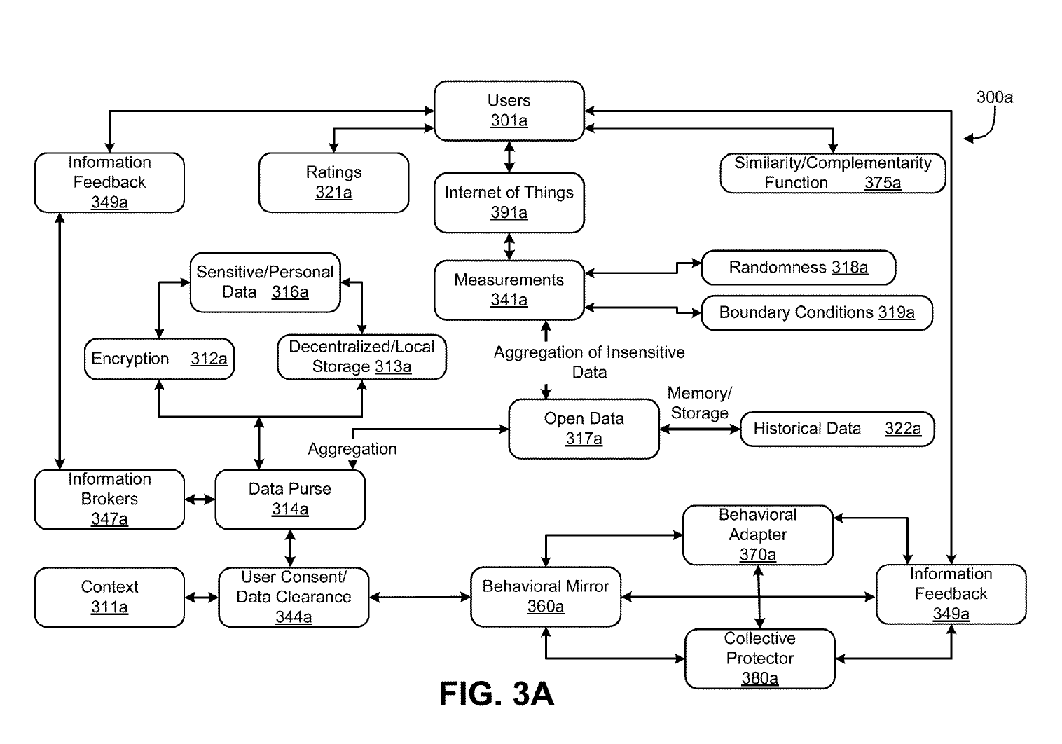

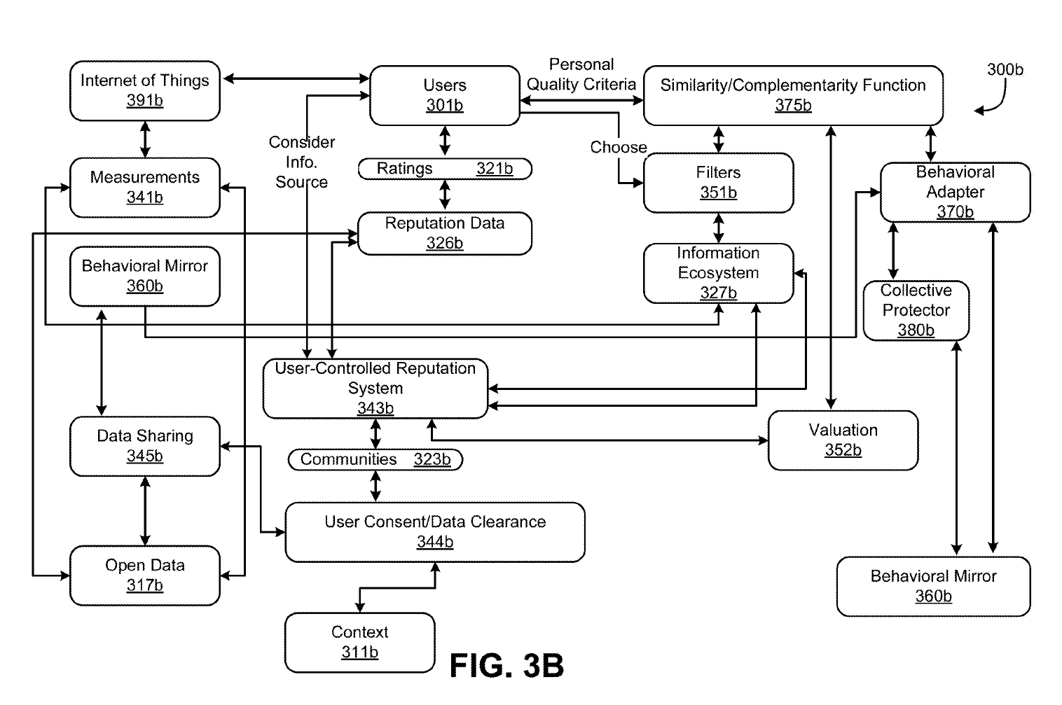

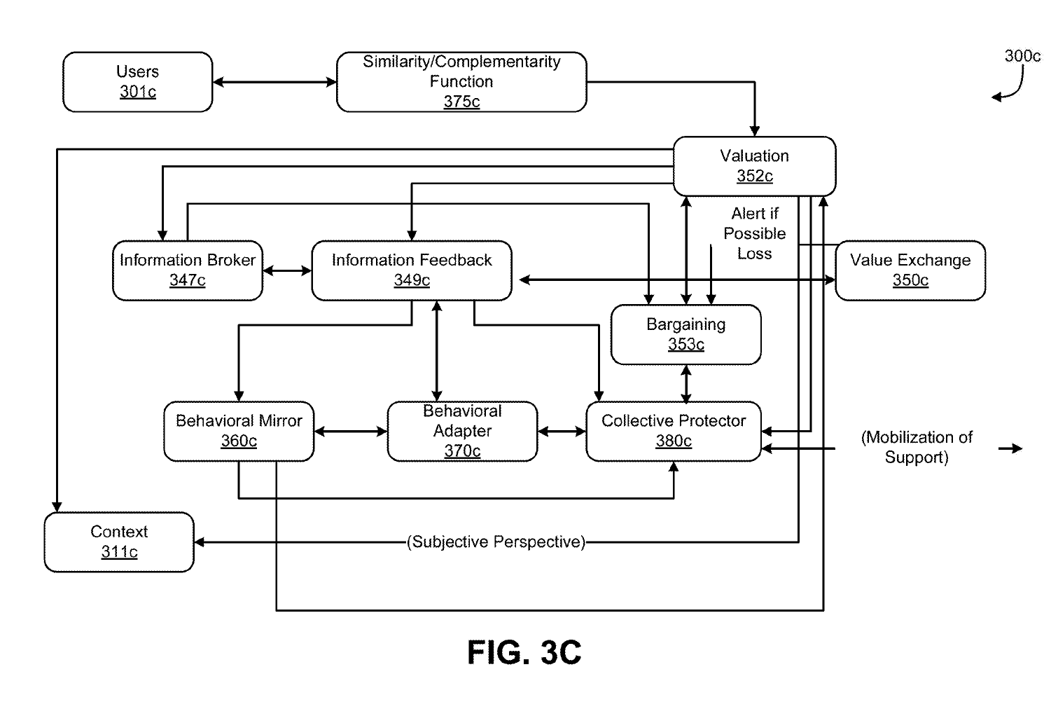

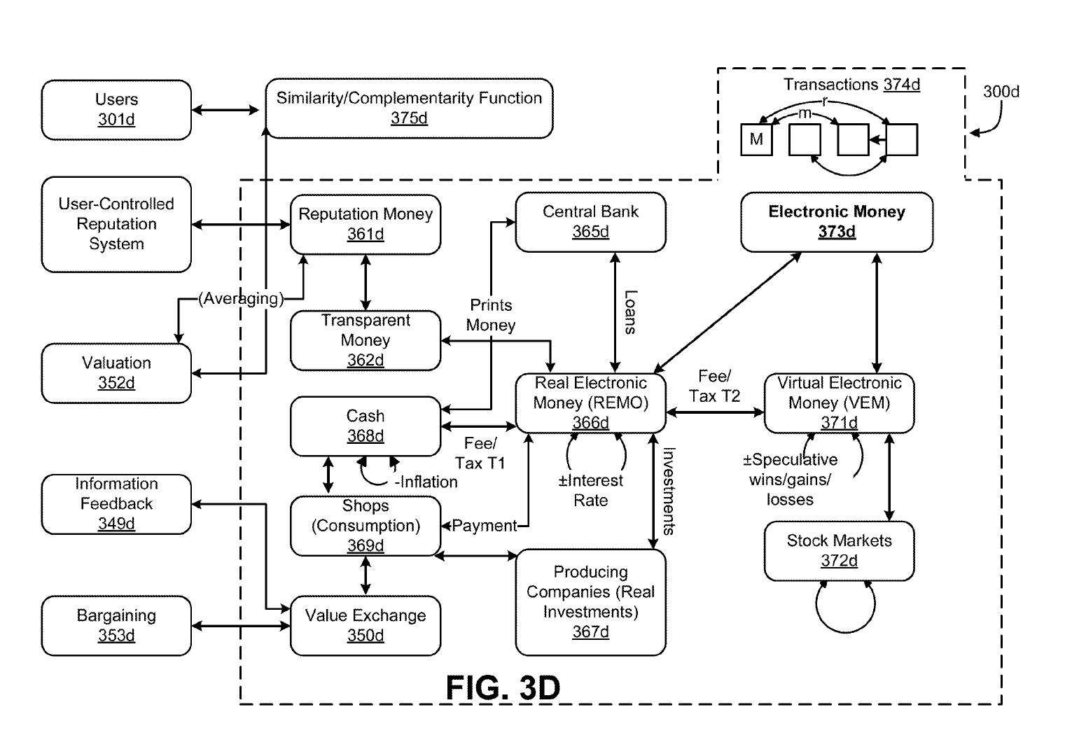

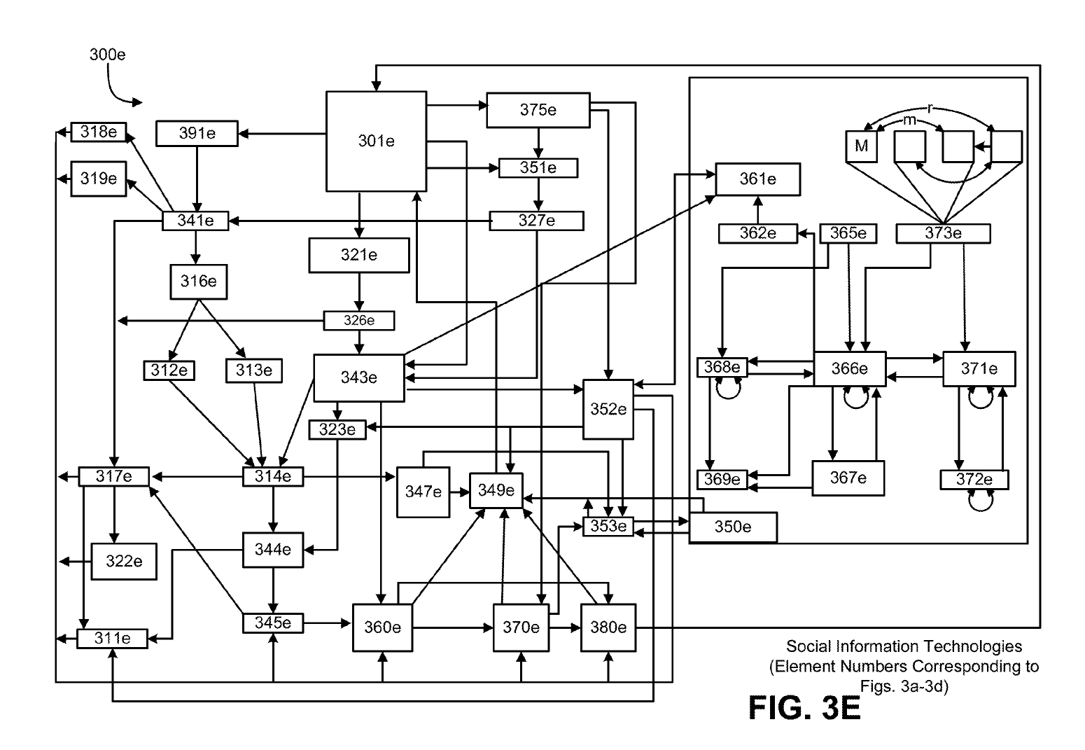

Measurements 241 can include the measurement of the behaviors or activities of system components, e.g., as a function of space and time, and/or network interdependencies. The measurements can be performed, for example, by means of the Internet or by sensor networks (such as the “Internet of Things”). Measurements generate data that are either insensitive or aggregated to create a database of public or open data, while sensitive (e.g., personal or confidential) data can be differently processed and stored, for example, in a data purse, as seen in FIG. 3A.

Ratings 242 can include information feedbacks by users, such as “likes,” ratings, up-votes, down-votes, karma points, comments, opinion polls, etc. and can be used to create a reputation database, which can be the basis of a reputation system 243. Similarities in ratings (as reflected, for example, by correlations in “likes”), can be used to define communities, for example, based on community detection algorithms.

Encryption, as seen in FIG. 3A, can include encryption of personal or other sensitive data, such as public-private key encryption, to protect data from misuse.

User consent/data clearance 244 can give a user control over his/her personal or otherwise sensitive data, i.e., to determine with whom these data are shared and for what purpose.

Data sharing 245 can include the sharing of data with other users, system components, etc. or with social circles or communities, for example, based on the exchange of a decryption code. Alternative methods of data sharing may similarly apply.

Alternative embodiments of data sharing can include the use of third parties, referred to as “information brokers” 247 to process data, which allows processes such as valuation, bargaining, value exchange or others without a direct exchange of sensitive data between the interaction partners. By means of decentralized information processing techniques, this can also be done in such a way that even the information brokers would have only access to meaningless or harmless bits of the information exchange.

Open data can be made publicly accessible without encryption and can include data shared with everyone based on informed consent or data clearance, as well as insensitive data, suitably aggregated data, and data that are too old to be considered sensitive.

User-Controlled Reputation System can include, for example, ratings and other user feedbacks that can be used to derive differentiated reputations of system components. These can depend on many factors, including, for example, reputation filters, which can be personally configured, shared, modified, and/or consider how trustworthy an information source is considered to be.

Valuation 252 can involve user- or component-specific (“subjective”) quality criteria that determine similarity and complementarity functions used to specify personalized filters/perspectives 251 and to valuate the expected outcome (value) of potential interactions. The valuation can be used to bargain a value exchange that enables the interaction partners to turn win-lose into win-win situations, or to establish a fairer (more balanced) sharing of the gains in win-win situations via a bargaining process 253.

The value exchange (also called value transfer or transaction) can be done with different monetary types 248, for example, with virtual or real electronic money, with transparent money or Reputation Money. Example embodiments can include different kinds of “money” such as cash, “real electronic money” (“REMO”), virtual electronic money (“VEM”), or multi-dimensional money, which can be used for certain exchange purposes and converted into each other in particular ways.

Transparent money, for example, can be real electronic money that can be turned into “Reputation Money” by publishing some transaction features, i.e., by creating some transparency about the money flows.

Other example embodiments can include, e.g., Reputation Money which can turn transparent money into “Reputation Money” by introducing one or several value-determining conversion factors that depend on certain reputation variables (of the transaction or of whoever owns the money, or context information).

FIG. 3A is an illustrative example of a block diagram 300a showing interconnected modules and components of the Social Information Technologies.

### Measurements

In example embodiments, measurements can be carried out at a measurements module 341a, using data from the Internet, from sensors and other sources. The creation of the “Internet of Things” 391a will be able to provide large amounts of data about almost everything in almost any location and in real-time or near real-time. Sensor networks, for example, may measure not just things that can be perceived with senses, but also radiation, chemicals, social links, psychological “mood,” etc.

### Input Variables

The behavior (or state) of a system component (no matter whether it is a “living” entity or a “non-living” system component) is potentially influenced by several factors, such as the following: history 322a (initial conditions, memory, learning), boundary conditions 319a (institutional, geographic and others), network interactions (characterizing the “social space”), context 311a (other variables, such as co-location, reputation, norms), or randomness 318a (errors, trial-and-error behavior, co-incidence, serendipity, etc.).

In some example embodiments, boundary conditions can, for example, be measured and quantified by global positioning system (“GPS”) data, remote sensing, and/or geographical information systems, network interactions can be quantified by social contacts as reflected by interactions via social media, via communication devices, or in space, randomness by estimating the noise (e.g., deviations from mathematical or algorithmic representations) using statistical procedures, context by quantifying the situational framing, such as local culture, including social norms and desirable/ideal behaviors (as described herein), considering also the individual (“subjective”) perspectives of system components (as described herein), and history by storing past measurements, or mathematical or algorithmic representations of them.

In example embodiments, in order to describe the behavior of a system component, one can generate a “subjective” representation of the world (considering the user's past, development, learning history, etc.), the physical and geographical space, the spatial interdependencies of interactions in it, related mobility/activity patterns, interactions with other system components, how interaction network links are established or cut, the artifact space (reflecting results of interactions of system components), and the level of randomness and selection as a function of the context.

Example embodiments include the specification of the context of a system component c by the combination of the spatial location x_{c}(t) (and its derivatives, such as the speed, direction, etc.), as well as the set of other entities e and objects o (in artifact space) with which it interacts. For example, assuming that living entities j and artifacts l have a set of objective, measurable properties pₑ and p₀, a system component's perspective or valuation through individual (“cognitive”) filters f(x_{c},e,o), gives the context “subjective” properties, which are changing over time due to the experiences made and the related learning processes.

Example embodiments include the measurement of objective and subjective properties, for example, by semantic differentials, by semantic networks and knowledge graphs (association patterns reflecting how closely certain properties relate to each other), by sets of living entities or artifacts sharing a property (positive link), and/or by contrast with entities or artifacts that do not share the property (negative link).

In example embodiments, measurements may be complemented by techniques such as (a) data analytics, (b) supervised or reinforcement learning, (c) neural networks, (d) other kinds of machine learning, (e) agent-based computer models, (f) other heuristics, techniques, or computational algorithms that are similar in purpose in order to quantify, based on measurements, circumstances that support the (a posteriori or probabilistic a priori) valuation of (past or potential) interactions, considering any of the following elements or any combinations thereof: (1) historical situation, (2) boundary conditions, (3) network interactions, (4) context, including subjective perspectives and valuations, and/or (5) randomness.

### Measurement Process

Contextual data can be collected by sensors of all kinds (optical, acoustic, physical, chemical, biological, and others), including those built into smart phones or other smart devices, which provide information about the outside world and/or extracted from activity data in the virtual/digital world (such as search requests in the Internet).

In example embodiments, sensors can be connected with the system components or located in the environment. For example, users can carry special high-tech glasses that have integrated sensors such as a GPS sensor, accelerometer, gyroscope, compass, video camera, microphone, or wireless communication. Alternative example embodiments extend also to other types of sensors that might be used in the future to measure brain, body or component behaviors or activities, or further properties.

In some example embodiments, in addition to evaluating “objective” data, individual relevance or meaning is also assessed. This valuation process can involve a “subjective mapping” (subjective picture or perspective), which translates “objective” into “subjective” contextual or other data. The underlying valuation or mapping may be inferred by combination of a variety of different datasets.

Example embodiments of measurement processes can include, for example, skin resistance and heart rate to determine the level of stress or happiness. Emotions can also be derived from visual recordings, as certain emotions are expressed by universal mimics. These can be determined from self-recordings, or by evaluating sensor data recorded and transmitted by others. Complementary to this, one might use electrocardiogram (“EKG”) and/or electroencephalography (“EEG”) or other brain activity data to determine the emotional state or other variables.

Further example embodiments can evaluate the way of speaking. For example, a semantic analysis of spoken words, whether from a human or an automated-machine, can give a picture of the level of happiness. One can also provide possibilities for people to comment (explicitly or implicitly) on situations (either by written or spoken words or by other forms of explicit or also implicit communication, as reflected by their own behavioral response, for example). Associations and connotations may be represented, for example, by tag clouds and semantic networks, association or knowledge graphs, or other techniques allowing one to reflect (cor)relations.

Recording data over time can eventually create a database of historical information about system components (subjects and objects), including relevant artifacts. Example embodiments can aggregate data over situations, individuals, or other variables, and implement “forgetting” of information in one way or another. Relationships between “objective” measurements and “subjective” valuations can be determined, for example, by machine learning techniques.

### Ratings and Communities

Whenever users valuate an interaction, this effectively establishes a rating. The ratings can concern, for example, system components, information about them and the quality of ratings. Ratings 321a can be done manually or by spoken word (using sentiment analysis, for example), and/or be inferred by sensing brain or body signals.

Ratings can be classified, for example, into “facts,” “opinions,” or “advertisements.” “Facts” would concern objectively verifiable information and would (have to) refer to an authoritative and independent piece of evidence (measurement, picture, video, scientific publication, or similar). Ratings that potentially generate a considerable individual benefit would be considered “advertisement.” All other ratings would be considered (subjective) “opinions,” in some such embodiments.

Ratings can be done on multiple scales, in order to consider different criteria that can be important. For example, they can be made in various categories c such as overall quality, quality of ingredients, environmentally friendly production, socially friendly production, durability, etc. This makes it possible to determine user communities with shared quality criteria, for example, by means of community detection algorithms. Users with shared quality criteria can be virtually connected together, i.e., an information exchange network can be established between them, even if they have not interacted with each other before.

In some example embodiments, sensitive and personal information can be encrypted in a way controllable by the respective user. Such sensitive and personal information would not be accessible to others without user consent. These data would be stored in a separate file or data structure associated directly with the corresponding user. The user would have control over the way these data are used. For example, a user would be able to comment on or hide digitally stored “opinions” of others on the user, and would be able to correct objectively wrong “information.”

The user can be enabled to decide, whether, when, and what kind of personal information (e.g., ratings, intimate, health, social, economic, or other kinds of information) he or she wants to make accessible to selected others, and for what purpose. This can require that a temporary consent of the corresponding user is given by “clearance,” “opt-in,” or other kind of user control. Users can also be given the possibility to be informed (“alerted”) what is being done with their data by whom (e.g., they can be provided with a copy of new data referring to them).

Example embodiments can include a data sharing of system components. For example, to share information, a user can pass a temporary decryption key on to other users for the sake of sharing some data. A user can share personal data with specific other users or “social circles” such as, for example, everyone (“open data”), colleagues, family members, friends, friends of friends, the own partner, and/or user communities.

In alternative example embodiments, instead of or in addition to an information exchange with the interaction partner (e.g., for the purpose of a matching or bargaining process), information exchange can be performed via third parties, which we will call information brokers (or also trusted brokers or trusted information brokers). For example, a process can be run anonymously on computational devices or computer systems of others, or it may even be distributed over several such devices, so that no other users can have access to sensitive or personal data (just to some bits of them). Computer systems may include any such device that is configured to process data.

In some embodiments, decentralized storage can be used to protect sensitive and private data better.

### Information Feedback to the User

The characteristics of system components (living entities, objects, or artifacts) can be represented to a user in various ways, e.g., by modifying the view through special video glasses in an augmented reality kind of way, by whispering information into the ears of the user, or by using any other kind of information transmission or perceivable signals (such as tactile stimulation, smells, tastes), or even neuronal stimulation. For example, using video glasses, one may visualize information by animated subjects (described in detail below), using universal mimics, by colored or flashing elements or any other meaningful representation that is suited to highlight certain kinds of information, by acoustic or other sensorial signals, brain stimulation, etc.

Example embodiments can include playfulness (“gamification”). For example, users may prefer to have a positive feedback that helps them to increase their strengths and to reduce their weaknesses. Depending on user preferences, the feedback can come from an avatar, which could be a comic figure or action hero or anyone a user would like to listen to or see (for example, his or her mother, a friend, some “guide”, or “professor”). These virtual characters can be embedded in an ambient world setting (“augmented reality”).

### Open Data

Open data 317a can be made accessible to everyone in an unencrypted way. Besides data that users decide to share with everyone, open data can also include aggregated statistics and averages of personal data of many users that do not allow one to track a specific user. Such information is relevant to determine the context, e.g., the “local norms” or “local culture.” Such statistics and averaging can be performed locally with anonymized data, before personal data are encrypted and stored.

FIG. 3B is an illustrative example of a block diagram 300b showing interconnected modules and components of the Social Information Technologies.

### User-Controlled Reputation System

Today's recommender systems provide individuals with one or a few perspectives that are specified by the provider (e.g., “most popular choices,” or “other customers who chose A have also chosen B,” or individually customized recommendations). Such recommender systems tend to manipulate decisions and may have undesirable side effects (such as undermining the “wisdom of crowds”). Alternative example embodiments include a user-controlled, multi-perspective recommender system that allows users to choose their own “perspective” by means of a personal information “filter,” such that the diverse filters applied by the users create differentiated multiple perspectives.

In example embodiments, filters creating such perspectives can be freely or commercially exchanged between users. The sharing, modification, and selection of filters can establish an “information ecosystem,” which would be steadily improving through an evolutionary, user-driven process. In this “information ecosystem,” different subjective, community-based, objective, normative, idealistic, virtual, hypothetical, or other perspectives could co-exist and/or compete.

An example embodiment of the User-Controlled Reputation System based on ratings can be a self-organized, trustable, and manipulation-resistant information ecosystem. Reputation systems can counter “tragedies of the commons,” which tend to occur in strongly interconnected systems, particularly in case of anonymous interactions. In particular, the establishment of a global reputation system can help to overcome “social dilemmas” (such as a lack of environmental-friendly behavior).

Example embodiments can include an option for users to post their ratings (likes, comments, etc.) anonymously, pseudonymously, or in a personally identifiable way. In the latter case, the user would have to be directly reachable by some means of communication and reply to it. Pseudonymous posts can be given, for example, a 10 times higher weight W₁ than anonymous ones and personal, for example, 10 times higher weight W₂ than pseudonymous ones.

If users post wrong information or classify posted information incorrectly (e.g., as “opinion” rather than “advertisement,” or as “fact” rather than “opinion”), as reported by, say, 10 others, the weight of their ratings (their “influence”) can be reduced, for example, by a factor of 10 (these values can be adjusted). All other ratings of the same person or pseudonym could also be reduced, for example, by a factor of 2. These factors are just exemplary and may be manually or automatically adjustable.

Let i be the rating individual and j represent the rated information/product/company/subject . . .. For heavy raters, the weight per rating j could go down with the number n of ratings. A possible specification can, for example, be wᵢ=qⁿ with q=0.9. If one does not rate for some time, the weights should slowly go back to 1. This can be reached by setting wᵢ(t+1)=q*wᵢ(t), if one is rating in time t+1, but otherwise wᵢ(t+1)=a+(1−a)*wᵢ(t), where a is a small positive number. This can reach that heavy raters i do not get too influential, i.e., it can reach a reasonable balance between raters.

Turning to a rated object j. Let the ratings rᵢⱼ of object j by individual i be scaled such that they fall in the interval [−1,1]. The ratings can be weighted with at the time tᵢⱼ of rating, and the factor fᵢⱼ (which could, for example, be set to 0.1, if the rating was pseudonymous and 0.01, if it was anonymous, otherwise 1). Moreover, a further factor such as p^{t-t}^{ᵢⱼ} with 0<p<1 can be used to reach that old ratings will eventually be forgotten, such that the reputation tends to go back to 0, if no new ratings are made. Hence, the average rating rⱼ(t) at time t can, for example, be specified by

$${r}_{j} ( t ) = {\sum }_{i} {r}_{i j} ( {t}_{i j} ) * {f}_{i j} ( {t}_{i j} ) * {w}_{i} ( {t}_{i j} ) * {p}^{t - {t}_{i j}} / {\sum }_{i} {f}_{i j} ( {t}_{i j} ) * {w}_{i} ( {t}_{i j} ) * {p}^{t - {t}_{i j}} = {〈 {r}_{i j} 〉}_{i} .$$

The variance Vⱼ²(t) of the ratings can be determined, for example, using the formula Vⱼ²(t)=<rᵢⱼ²>ᵢ−<rᵢⱼ>ᵢ²,

where <. . . >ᵢ represents the weighted mean value over i. Vⱼ can be used to identify the level of disagreement in the ratings (“controversy”).

The overall importance I of j from the perspective of the subjects i is determined from the relative frequency of ratings as compared to the overall number Nⱼ of page visits. One can use a decaying memory function by defining, for example,

$${I}_{j} ( t ) = {\sum }_{i} {d}_{i j} ( {t}_{i j} ) * {p}^{t - {t}_{i j}} / {\sum }_{i} {p}^{t - {t}_{i j}} ,$$

where dᵢⱼ=1, if a rating was made during a website visit or so starting at time tᵢⱼ, otherwise dᵢⱼ=0. The value of p can be chosen as a function of the number of ratings. For example, if there are many ratings, the value could be chosen smaller, such that old ratings become irrelevant more quickly. This makes sense, for example, for news or fashion articles, in which people quickly lose interest.

The above sums can be updated in a computationally and storage-efficient way. For example, if they have been updated at time t′ for the last time, and there is a new rating at time t, then, the nominator Nⱼ(t) of

rⱼ(t)=Nⱼ(t)/Dⱼ(t)

is just

Nⱼ(t)=Nⱼ(t′)*p^{t-t′}+rᵢⱼ(t)*fᵢⱼ(t)*wᵢ(t)

and the denominator becomes

Dⱼ(t)=Dⱼ(t′)*p^{t-t′}+fᵢⱼ(t)*wᵢ(t).

Hence, it is sufficient to store the nominators and denominators and the previous updating time t′, while the previous values do not need to be stored, which is in favor of a privacy-friendly data processing. However, other embodiments may store such previous values.

The assumed rating database can allow everyone to run his/her own reputation filters, which weight the ratings in different ways. For example, ratings of friends can be increased, while ratings from less trusted information sources can be reduced.

FIG. 3C is an illustrative example of a block diagram 300c showing interconnected modules and components of the Social Information Technologies.

### Behavioral Mirror: Examples of Different Kinds of Behavioral Mirrors

Example embodiments of Behavioral Mirrors can be “absolute mirrors” (which try to give a representative picture of an individual or several individuals) or “relative mirrors” (which contrast the representative picture with a reference picture). One can furthermore create “public” and “private” mirrors, either producing pictures of individual behaviors that everyone can access or ones that are only privately accessible. In other words, private mirrors provide a picture only to oneself, while public mirrors provide the picture to everyone. While private mirrors can support the orientation of individuals in their respective social context, public mirrors can promote social norms, as they make deviant or undesirable behavior visible to everyone. Example embodiments of “community-specific mirrors” can be mirrors that are accessible only to a restricted community of users (e.g., a group of direct or indirect friends as identified by a social network). Furthermore, one can create “normative” and “idealistic” mirrors. Normative mirrors can, for example, compare one's behavior with the average behavior of others, while idealistic mirrors can, for example, compare one's behavior with some desirable, “ideal” behavior. The comparison can be local, global, community-based, or a combination thereof.

### Behavioral Mirror: Idea and Functional Principle

Most people love to see themselves on pictures or in mirrors, and they are usually keen to appear beautiful. Similarly, the Behavioral Mirror can create a desire to increase the “behavioral beauty.” It gives a feedback, how the behavior of a system component is perceived, compared to the local context, and it gives an idea of the possible impact of and response to certain behaviors. The data for this Behavioral Mirror can come from ratings, but much more. For example, sentiment analysis can be applied to written and spoken words, thereby gathering the essence of people's points of view. (Such points of view can be anonymized and aggregated.) In some example embodiments, a person could wear, Google Glass®. Electronic goggles or input devices like this can be used to analyze people's reactions to certain behaviors. In such ways, one can get a better and better picture of local norms and expectations over time. Other devices, such as cameras located on personal electronic devices, or public cameras could also be integrated into example embodiments of the system in order to gather additional information and data from third-party sources.

For example, if people stare at you, you may want to know what is wrong. You may transmit this question to the surrounding people, who may send a feedback such as: “You should stand in line” or “Your flies are down” or “You might want to get a new haircut” or “Your tie is outdated.” Some of this information can also be inferred from the gazing direction, and a simple response can be to transfer a snapshot of the irritating detail.

Behavioral Mirrors can transfer much more sophisticated information, e.g., on social conventions, norms, and cultural habits. The Behavioral Mirror can, for example, be able to tell a user: “there is someone who admires you,” or “. . . has a positive opinion about you,” or “. . . would like to get acquainted to you,” or “there is someone who shares your point of view, or has a complementary set of knowledge. Maybe, you want to talk to him or her?” or “there is someone who has a problem with your kinds of views and values. Better keep some distance.”

Example embodiments of Behavioral Mirrors enable more favorable (value-increasing) interactions, thereby reducing missed opportunities, and help to avoid conflicts and interaction that would be unfavorable (value-decreasing).

Example embodiments of Behavioral Mirrors can create “behavioral pictures” from “behavioral data sets” by means of “behavioral perspectives.”

Example embodiments of behavioral datasets can be any datasets reflecting individual or collective behaviors, activities or decisions, such as ratings, “likes,” search requests, tweets, blogs, other kinds of activity patterns (such as location, mobility or consumer data) or any kind of behaviorally relevant information.

Example embodiments of behavioral pictures can include mathematical, computational or other representation of individual or collective behaviors that can be processed, e.g., by human senses or brains. Behavioral pictures could also be recorded and analyzed by a data processing device, such as a computer running behavioral analysis software, which could present a user with reports or data.

Example embodiments of behavioral perspectives can include technical procedures to generate particular pictures from behavioral datasets. For example, processing behavioral data with different mathematical functions or computational filters creates different perspectives.

Example embodiments of Behavioral Mirrors can include technical devices that create particular behavioral perspectives (e.g., individual or community-specific perspectives). Note that, in some example embodiments, the behavioral picture may change, when the perspective or the behavioral dataset changes.

The principle of Behavioral Mirrors is not restricted to the above examples. Alternative example embodiments include extensions to other ways of generating pictures of individual or collective behaviors.

According to example embodiments presented herein, pictures of mirrors, as referred to herein, can be created by defining mathematical or computational operations that generate understandable representations of individual or collective behaviors, or contrast individual behaviors, or individual behaviors with collective behaviors. The representations and comparison may be based on actual, hypothetical, virtual, expected, or desired behaviors.

Actual behaviors often deviate from the desirable or expected behaviors. Desirable behaviors of a community are generally reflected by values and ideals, while collectively expected behaviors are generally reflected by social norms.

Behavioral Mirrors can, for example, be created, in one or more of the following ways: (1) Mine behavioral datasets, which, to protect privacy, can also be done on the computational device of the user or on computational devices of information brokers, if sensitive personal data are involved; (2) represent (e.g., visualize) relevant characteristics of individual behavior to give a picture of it, thereby creating an “individual picture,” as generated by an absolute mirror; (3) determine averages (or also medians or other relevant statistical indicators) locally, globally, or community-specific (based, for example, on friendship or interaction networks, similarities in tastes or behaviors, etc.); (4) contrast the individual picture with the average picture as created by relative mirrors, to determine, for example, a picture of the realistic mirror; (5) determine expected and desirable behaviors (as described herein); (6) contrast the individual picture with the expected or desirable behaviors as measured by a normative or idealistic mirror; (7) make the pictures of the mirrors understandable to the users, for example, by a suitable visualization; or (8) make pictures accessible to the desired recipient(s) depending, for example, on whether the pictures are intended for private or public or community use.

Further example embodiments can include the use and/or implementation by artificial intelligence kind of system components, such as systems or algorithms that can take autonomous decisions based on information about one or more surrounding systems or environments, such as trading algorithms in financial markets.

Example embodiments of measuring social norms include methods, systems, and computer-implemented methods to measure social norms by means of opinion polls (e.g., online polls), or by determining the price (financial compensation) or estimated price that individuals want to be paid in compensation for the (hypothetical) publication of a certain private behavior. The above measurement approach makes use of the circumstance that individual deviations from social norms are often sanctioned. Therefore, individuals usually try to avoid that others learn about deviant behavior. The publication of deviant behavior would expose the respective individual to a risk of discrimination and sanctioning. This would create disadvantages for which an individual would want to be compensated. While individuals are typically not afraid that their reference community learns about behaviors that conform to the community norms, the amount of expected compensation for the publication of private, deviant behavior increases with the disadvantage expected from such publication (e.g., the strength of sanctioning deviant behavior), for examples, with the amount of deviance from the expected behavior. Hence, the expected behavior (“social norm”) of a community can be defined as the behavior, for which the expected financial compensation in case of publication is minimum.

Alternative example embodiments of measuring social norms include measuring social norms automatically by determining the average individual behavior, based on the mining of actual user behaviors. The expected strength of sanctioning deviant behavior can be estimated via the inverse of the variability of individual behaviors.

Example embodiments of measuring desirable/ideal behaviors include measuring desirable behaviors by opinion polls determining the amount of money that individuals would be willing to pay, if others would show a particular behavior. The desirable, ideal behavior corresponds to the behavior, into which people would invest the highest amount of money.

Alternative example embodiments of measuring desirable/ideal behaviors include procedures to determine amounts of money that users are willing to pay for particular behaviors, using information collected by a value exchange system, for example from value transfers aiming to establish interactions that would otherwise be win-lose interactions.

### Behavioral Adapter

Everyone is different, and this is what makes life difficult and creates conflict. However, diversity is one of the main drivers of innovation.

Example embodiments of Behavioral Adapters can enable people to cope better with diversity and to manage the balancing act between different kinds of interests, for example, by combining information from several Behavioral Mirrors or by using information from a pluralistic or user-controlled Reputation System. The overall approach is to support more favorable (value-increasing) interactions with other system components, and to avoid non-beneficial (value-decreasing) interactions.

In some example embodiments, while the Behavioral Mirror can be seen as a self-centered or user-centric device, the “Behavioral Adapter” can be seen as an other-regarding device. Both might be run on the same kind of technology, e.g., Google glass®.

A Behavioral Mirror could, for example, tell a user: “This has been really nice of you,” or “Here you could have been a bit more diplomatic, in your own interest,” or “It's great that you have been consuming 5% less fuel this week, thereby reducing CO₂ emissions,” or “You have had 3 steaks this week already, what about having this vegetarian dish today, which has been recommended by many others?” or “Given your and your friends' music taste, what about going to the concert of xyz in a month—they will be on stage just an hour from here?”

Note that Behavioral Adapters can promote undesirable assimilation, if the previous specifications regarding data management, data sharing, privacy, and self-determination are not properly implemented.

### Functional Principle

People with different cultural or personal backgrounds have different behavioral expectations with respect to others. This often creates misunderstandings, inefficient exchange (of money, ideas, goods etc.), missed opportunities, or transaction failures (i.e., situations in which no agreement is found), or conflicts. These problems can be avoided or mitigated by “Behavioral Adapters,” which can make the intentions or expectations of interaction partners understandable, warn of unfavorable interactions, or support favorable ones, for example, by bargaining or executing a value exchange.

In example embodiments, Behavioral Adapters can support the coordination between people or companies with different sets of interests, values and quality criteria, and point to beneficial transactions and expected win-win situations (“good deals”). They can help people with mutually compatible interests to find each other and to make their bargaining more efficient and profitable.

Example embodiments of Behavioral Adapters can be imagined to work similar to a guide or insider providing orientation.

Example embodiments of Behavioral Adapters can be created in the following way: When two users interact with each other, they decide what kind of information to share with the other person (e.g., by passing on a temporary decryption key). As their interaction or negotiations progress, they may successively share more information. For example, they can establish a data exchange between mobile devices and transfer their mutual expectations. This allows them to compare their behavior or intended behavior with the expected or desired one and to adapt accordingly.

Example embodiments of Behavioral Adapters can execute sensitive information exchange, bargaining, and value exchange processes on behalf of the (potential) interaction partners through distributed information brokers (e.g., neutral third parties), such that the (potential) interaction partners do not exchange information with each other directly and the information brokers have only access to meaningless pieces of sensitive information.

Further example embodiments can use information from reputation-based recommender systems.

Behavioral Adapters can consider a number of additional issues: (1) Social norms are changing over time. (2) Social norms might vary from one area to another. (3) Social norms can be better understood by contrasting different cultures. (4) For users with different cultural backgrounds, it might largely differ what behaviors they perceive as critical and, hence, it might be very different what norms they find particularly important to consider.

Example embodiments of Behavioral Adapters can measure expected and/or desirable behaviors from the perspective of each user and provide corresponding information feedback. Behavioral Adapters can reveal (local) cultures, for example, by contrasting the local norms of two cultures, and/or their respective values/ideals.

Further example embodiments of Behavioral Adapters can offer a real-time or near real-time translation from one language to another. To avoid critical misunderstandings, it can be important to signalize cases, where the translation might not fit the intention well. This concerns also cases of humorous or sarcastic statements, or when the content of a statement does not fit the context. This can help people to clarify potential misunderstandings.

### Collective Protector

Example embodiments of Collective Protectors include methods and systems to protect users from violence, destruction, exploitation, conflict, or other harm. Collective Protectors can warn users of risks and dangers, in particular of interactions or transactions, which would be lossful or unfair. They can help to avoid such interactions, organize social support, or bargain a fair compensation.

Alternative example embodiments of Collective Protectors can work like a kind of immune system, i.e., a decentralized system that responds to changes in the environment and checks out the compatibility with their users' values and interests. If negative externalities are to be expected (i.e., if the interaction would be value-decreasing), a protective “immune response” would be triggered to avoid or mitigate the lossful interaction.

Some example embodiments can include an alarm system, for example, a kind of “radar” system that alerts a user of impending dangers and makes him/her aware of them. In fact, the “Internet of Things” can make changes—gains and losses—measurable, including psychological impacts such as stress, or social impacts, such as a loss or gain in reputation or power.

Further example embodiments of Collective Protectors can help users to solidarize themselves against others who might attack or exploit them.

Such social protection can be thought of as a form of crowd security, which can sometimes be more effective than long-lasting and complicated lawsuits. Of course, protection by legal institutions would further exist, but it would be more like a last resort, when social protection fails, e.g., where it is needed to protect someone from organized crime. Some example embodiments can use a reputation system to discourage exploitation or aggression.

FIG. 3D is an illustrative example of a block diagram 300d showing interconnected modules and components of the Social Information Technologies.

### Valuation

The valuation 352d of an interaction serves to determine the “payoff” or “success,” i.e., the degree to which the interaction is favorable or unfavorable for the corresponding system component (and the interaction partner). The result of the valuation can depend on the respective context or history (and on all other determinants as described herein).

The valuation can be done by determining how profitable an interaction would be, or by determining how similar the outcome \vec{x} of an interaction or a potential interaction is to a certain desired, “ideal” outcome \vec{y}. This similarity may be measured in various ways, e.g., by means of (small) distances, (high) correlations, or (low values of) Theil's inequality coefficient. One example of a general distance measure is the Mahalanobis distance, defined as

d(\vec{x}, \vec{y})=\sqrt{(\vec{x}−\vec{y})S(\vec{x}−\vec{y}),}

where S is a symmetric matrix (such as the unity matrix), \vec{y} is the desired outcome, and \vec{x} the actual outcome. Depending on the situation, other specifications can be used as well.

### Bargaining 353d

The valuation 352d can be used to decide whether a potential interaction would be beneficial to perform and/or to bargain a value exchange that enables the interaction partners to turn win-lose into win-win situations, or to establish a fairer sharing of profits (or gains) in win-win situations.

For example, assume that the value (“payoff”) of an interaction of a focal system component is A the value for the interaction partner B, and A+B is positive. If B<0, one interaction partner would not be interested in the interaction, even though it would create an overall benefit. However, if the focal component compensates the interaction partner with a payment, this can turn the win-lose situation into a win-win situation for both. To create a mutual or bilateral benefit in such interactions, one needs to be able to determine the payoffs of both sides and have an efficient bargaining mechanism to redistribute the payoffs. Overall, many people tend to accept and prefer a fair sharing, such that everyone would get (A+B)/2 in the end, but many people also accept that taking risks, making investments, and particular preparatory efforts deserve to be compensated for as well. Gains can, for example, be redistributed proportionally to the respective investments I and J, and risks can be covered by an insurance premium C. One possible way of sharing would therefore be reflected by formulas such as

(A+B−C)*I/(I+J)

and

(A+B−C)*J/(I+J).

Ideas, initiative, and efforts can, for example, be considered as investments.

### Value Exchange and Kinds of Money

The value exchange may be done with “virtual” or “real” electronic money 373d, with “transparent money” 362d, multi-dimensional money, or “Reputation Money” 361d (as described herein).

### Kinds of Money

Example embodiments include, besides goods, three kinds of money: (1) Cash 368d, (2) “virtual” electronic money (“VEM”) 366d, and (3) “real” electronic money (“REMO”) 371d. Other types of money or monetary information (such as Bitcoins, for example) can be similarly used. Cash and REMO can be used for real investments, VEM for speculation in stocks 372d or other financial products. When the conversion of REMO into Cash or VEM is associated with a fee or tax rate that is higher than for conversions of Cash or VEM into REMO, this can promote accountable (electronic) transactions and encourage consumption and real investments. The conversion fees or tax rates can be adjusted (e.g., by the central bank 365d). The above described kinds of money will be particularly effective in promoting consumption and responsible financial exchange, when cash loses value over time (“inflation”).

### Transparent Money

One problem with our current money is very similar to today's Internet: anonymous exchange allows for exploitation, crime, and malicious activities, in other words, a downward (ethical) spiral. To promote responsible financial exchange, REMO and VEM can be turned into “transparent money” by publishing certain features of the financial transactions, which can, for example, be decided politically. While this would not change the value of any financial transactions, transparency is expected to encourage (more) responsible transactions. “Reputation Money” would even reward them.

### Reputation Money

Transparent money becomes “Reputation Money” by introducing a value-determining conversion factor, which depends on certain reputation variables (so-called “qualifiers”) of the transaction or of whoever owns the money. Such qualifiers can, for example, be the origin of money, the destination location, the kind of goods bought and their reputation, or the reputation of the producer, seller, or owner. Units of Reputation Money can be traded like stocks, national, regional, or local currencies.

In an example embodiment, the conversion factor of a money unit mⱼ with reputation rⱼ can be (1+rⱼ), and the value of that money unit

mⱼ*(1+rⱼ).

One possible example embodiment would be a new kind of cash with a memory chip in it, which stores certain qualifiers of its past transactions, or at least its amount mⱼ and current conversion factor rⱼ.

In an example embodiment, if a user (e.g., individual or company) earns various amounts mⱼ of money with the diverse reputations rⱼ, the overall amount of money on a bank account where these money units are saved, can, for instance, be defined by

$$M = {\sum }_{j} {m}_{j} ,$$

and its overall value by multiplying this amount M with (1+R), where

$$R = {\sum }_{j} {r}_{j} * {m}_{j} / {\sum }_{j} {m}_{j} .$$

Then, the reputation R of the overall amount M of money corresponds to the average reputation of the money units mⱼ. In this way, splitting the overall amount of money over several bank accounts does not change the overall value of money. The situation of today corresponds to reputation values of zero. This fact allows one to introduce Reputation Money quite easily by setting the initial reputation values for all electronic money to zero. However, defining qualifiers that can increase or decrease the reputation of money units creates new opportunities to increase the value of money by improving the qualifiers determining the reputation (e.g., by producing and offering better quality products or services).

In some example embodiments, in order to incentivize and reward higher quality, a user or entity can couple the reputation of money with the reputation of the owner. In such an example embodiment, the own reputation could determine the value of the money owned.

To illustrate an example embodiment, assume that a customer wants to buy certain products j in a shop, and that they cost mⱼ money units and have the reputations rⱼ. Furthermore, let us imagine that the prices pⱼ=mⱼ*rⱼ are published via electronic price tags or that people can view them on their smartphone or another reading device by scanning a product code. The overall amount to be paid for all chosen products can then, for example, be set to

$$P = {\sum }_{j} {p}_{j} ,$$

and a customer with reputation R would have to pay M=P/R from his/her account.

In example embodiments, if individuals decide, for privacy or other reasons, not to make their reputation value available, the reputation value can be set to 0 or some other value when appropriate or determined based on outside factors.

In example embodiments, one can replace negative reputation values by zero in value exchange processes. This can limit reputational risks for the value of private property.

In other example embodiments, the diverse reputation values rⱼ might be used to define multiple kinds of money mⱼ*rⱼ with limited or no convertibility between each other, thereby creating “multi-dimensional money.”

In other example embodiments, the reputation values rⱼ might be used to determine groups of people, who perform transactions together (e.g., create a common good) based on their investments mⱼ.

In other example embodiments, multi-dimensional money may reflect different kinds of incentives (points, scores, digital medals, ranks, digital hearts, and other kinds of acknowledgments), human or social capital (knowledge, reputation, etc.), or externalities (noise, different kinds of emissions, damages or benefits, various kinds of risks or opportunities, diverse impacts on the environment, on things, people, companies, institutions, or anything else). Multi-dimensional money might be imagined like administering different kinds of “accounts.” The novelty of multi-dimensional money is that there is only a very restricted or even no convertibility between the different money dimensions. This is necessary to qualify them as feedback control variables for the design of self-organizing techno-socio-economic-environmental systems. Another novelty is that some of the money dimensions (for example, social capital such as reputation) might be perishable or multiplicative or may have other non-traditional features, such that they do not follow classical accounting rules.

In example embodiments, limited or no convertibility between different kinds of money can be reached by introducing finite taxes or transaction costs, where a hundred percent of transaction costs would entirely prevent transactions between different money dimensions.

FIG. 3E is an illustrative example of an environment 300e showing the interconnections of all servers, modules, engines, and information from FIGS. 3A-3D using the reference element numbers.

Example embodiments of the present invention include information technologies or data measurement, storage, processing and communication/exchange procedures (1) making the occurrence of systemic instabilities/failures or conflicts less likely by encouraging, modifying, or avoiding interactions between system components (depending on whether they would be win-win, good or bad win-lose, or lose-lose situations), (2) building on sophisticated methods to reach situational/contextual awareness in order to reduce missed opportunities and/or lossful interactions, (3) creating incentives for systemically favorable kinds of interactions and/or supporting a value transfer.

Further example embodiments of the present invention include information technologies or data measurement, storage, processing and communication/exchange procedures to align the value-oriented interests of a system and its individual system components (such as users, companies, autonomously deciding robots or computational devices, context-sensitive algorithms, or an adaptive environment), based on their respective, “subjective” valuation of (potential) interactions and an exchange of related information, such that (1) favorable (win-win) interactions are performed, (2) unfavorable (lose-lose or bad win-lose) interactions are avoided, and/or (3) good win-lose interactions are turned into win-win interactions or win-win interactions are made fairer by means of a bargaining and value exchange process, thereby increasing the overall benefits of the system and its components, and/or reducing systemic instabilities and failures. For example, this can be done by the Behavioral Adapter, the Collective Protector, and/or Value Exchange, or a variation or combination of these or similar Social Information Technologies.

Example embodiments of the present invention include information or value exchange system combining a protection of sensitive data with a degree of transparency (that can, for example, be reached by means of suitable reputation systems and/or information systems with similar effects), such that it can promote responsible interactions (in the sense of avoiding win-lose or lose-lose situations) and avoid “tragedies of the commons,” i.e., systemically (and often also individually) undesirable outcomes. For example, this can be done by the “Behavioral Mirror,” “Transparent Money,” and/or “Reputation Money,” or a variation or combination of these or similar Social Information Technologies.

Example embodiments of the present invention include information and/or value exchange systems allowing to promote responsible actions, accountable transactions and/or encourage consumption, for example in shops 369d, or real investments, for example via producing companies 367d, by distinguishing different kinds of money, such as cash, “real electronic money” (“REMO”), and/or “virtual electronic money” (“VEM”), and introducing (a set of) suitable exchange fees or taxes for converting different kinds of money into each other. For example, this can be done by the “Value Exchange” or a variation this or similar Social Information Technologies.

Further example embodiments include measurement and estimation procedures based on the Internet and/or sensors or sensor networks to quantify context such as, for example, social norms, desirable/ideal behaviors, or local culture, which can influence autonomous decision-making about a (potential) interaction, in particular when a subjective picture or valuation of objectively measureable variables is involved. For example, this can be done by the “Behavioral Mirror” or a variation of this or similar Social Information Technologies.

Further example embodiments include measurement and information feedback procedures using the Internet and/or sensors or sensor networks (1) to determine expected behaviors or (local) social norms by averaging over actually measured behaviors, or (2) to infer desired/ideal behaviors from value exchange transactions, or (3) to determine local cultures as sets of local norms, in particular, by contrasting with local norms in other contexts, and (4) to make these understandable to a user, (5) with or without the application of reputation and/or recommender systems. For example, this can be done with the User-Controlled Reputation System or a variation of this or similar Social Information Technologies.

Further example embodiments include measurement and estimation procedures based on the Internet and/or sensor networks to quantify circumstances that can support the (a posteriori or probabilistic a priori) valuation of (past or potential) interactions, considering any of the following elements or any combination thereof, not protected as intellectual property so far: (1) historical situation, (2) boundary conditions, (3) network interactions, (4) context, including subjective perspectives or valuations, (5) randomness, where the procedures may or may not involve techniques such as (a) data analytics, (b) supervised or reinforcement learning, (c) neural networks, (d) other kinds of machine learning, (e) agent-based computer models, (f) other heuristics, techniques, or computational algorithms that are similar in purpose. For example, this can be done by the “Behavioral Mirror” or a variation of this or similar Social Information Technologies.

Further example embodiments include reputation and/or recommender systems with the following elements/features or any combination thereof, where not protected as intellectual property so far: (1) pluralistic (in particular, user-controlled rather than centrally controlled), (2) based on multiple criteria rather than using just one reputation scale, (3) participatory and open, (4) enabling personally configurable and socially sharable information filters to determine reputation and recommendations, (5) supporting a self-organized, trustable, and manipulation-resistant (eco)system of information and information filters, (6) allowing anonymous, pseudonymous, and personalized ratings and weighting them differently, (7) classifying different kinds of information such as “opinions,” “advertisements,” and “facts,” (8) establishing a balance between frequent and less frequent raters by adjustable rating weights, (9) implementing an eventual forgetting of old ratings, (10) allowing to weight different raters or sources of information differently, depending on how much the user trusts them, (11) evaluating the level of disagreement (“controversy”), (12) determining the overall importance, (13) determining the aggregate reputation values in a computationally and storage-efficient way. This can be done, for example, by the User-Controlled Reputation System or a variation this or similar Social Information Technologies.

Further example embodiments include data storage, processing and communication procedures requiring an exchange of information between (potential) interaction partners in a way that protects privacy, personal data, or any other kind of confidential or sensitive information, based on the principle of using distributed “information brokers” (i.e., neutral third parties) to execute the sensitive information exchange on behalf of the (potential) interaction partners (e.g., to perform a bargaining process), such that the (potential) interaction partners do not exchange information with each other directly and the information brokers have only access to meaningless pieces of sensitive information. Similar procedures, combined with any of the following elements or any combination thereof, to make data storage, processing, or exchange less sensitive: (1) anonymization, (2) data aggregation (such as averaging), (3) obfuscation, (4) user-controlled encryption and decryption procedures, (5) use of decentralized data storage, (6) further known methods to protect sensitive data.

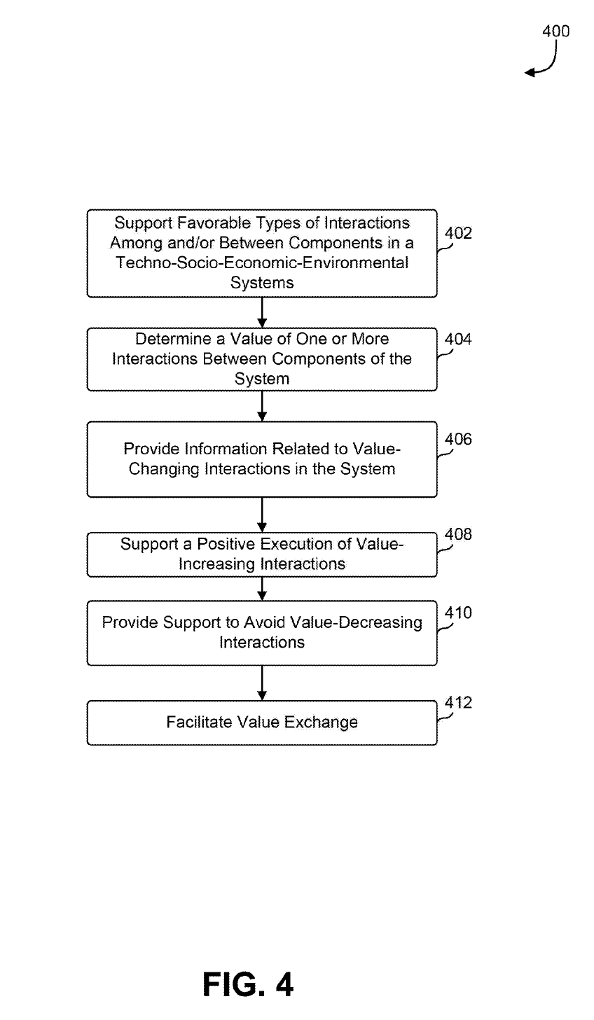

FIG. 4 is an illustrative example of a process 400 for interactions using the Social Information Technologies in accordance with at least one embodiment. The process 400 may be accomplished by a server, such as the Social Information Technologies server 110 depicted and described in connection with FIG. 1 or a suitable component thereof or a suitable component thereof or as a decentralized solution rather than a server-based solution. As illustrated in FIG. 4, the process 400 may include supporting favorable types of interactions among and/or between components in a techno-socio-economic-environmental system (402). Determining a value of one or more interactions between components of the system (404) and providing information related to value-changing interactions in the system (406). Supporting a positive execution of a value-increasing interaction (408), providing support to avoid value-decreasing interactions (410), and facilitating a value exchange between the components (412).

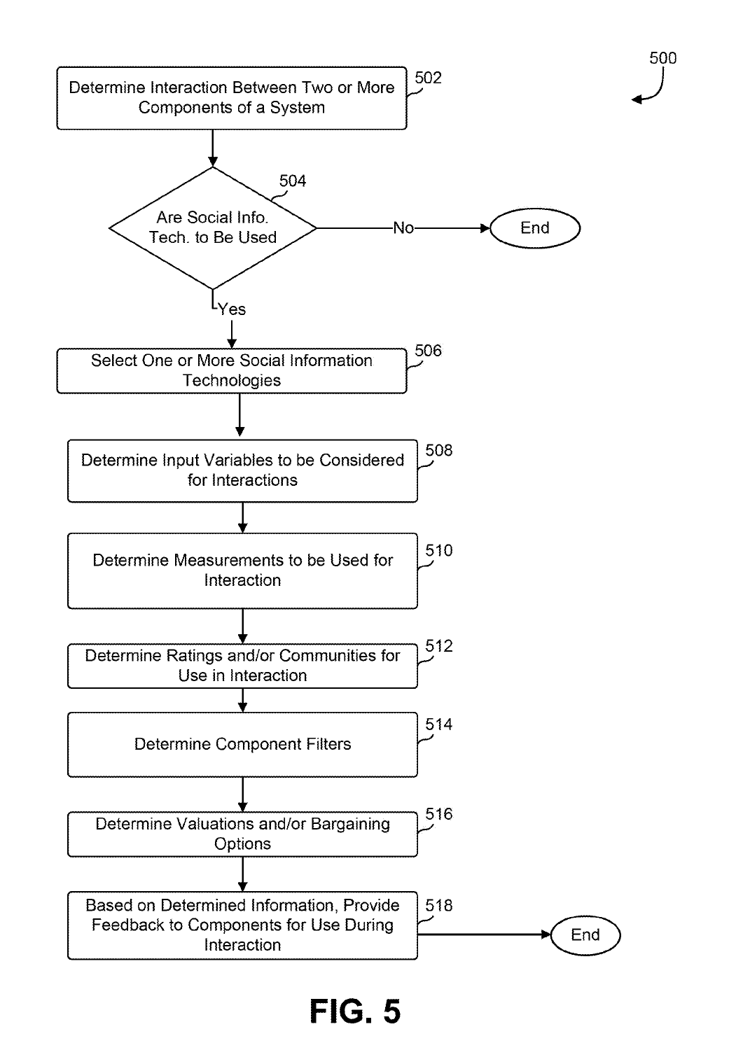

FIG. 5 is an illustrative example of a process 500 for interactions using the Social Information Technologies in accordance with at least one embodiment. The process 500 may be accomplished by a server, such as the Social Information Technologies server 110 depicted and described in connection with FIG. 1 or a suitable component thereof or as a decentralized solution rather than a server-based solution. As illustrated in FIG. 5, the process 500 may include determining an interaction between two or more components of a system (502). The process 500 further determines if Social Information Technologies are to be used in conducting the interaction (504); if not, the process is complete. If Social Information Technologies are to be used, the process 500 continues by a server selecting one or more Social Information Technologies (506). The process 500 continues by determining input variables to be considered for the interaction (508). The process 500 continues by determining measurements to be used for the interaction (510), determining ratings and/or communities for use in the interaction (512), determining component filters (514), and determining valuations and/or bargaining options for the interaction (516). Based on the determined information, provide feedback to components of the system for use during the interaction (518).

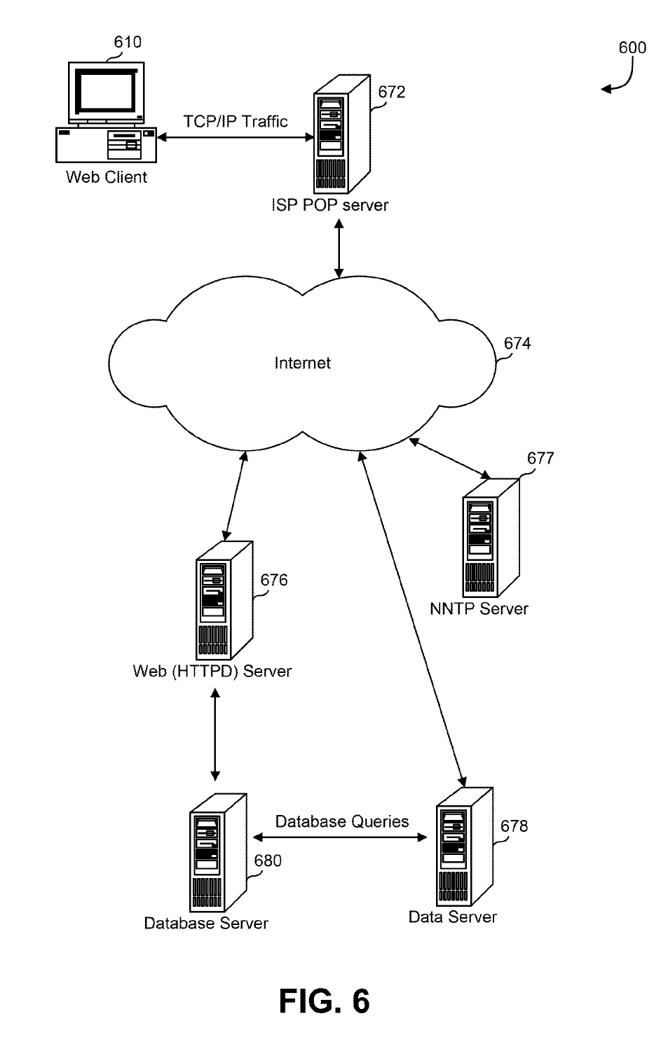

FIG. 6 illustrates aspects of an example environment 600 for implementing aspects in accordance with various embodiments. As will be appreciated, although a web-based environment is used for purposes of explanation, different environments may be used, as appropriate, to implement various embodiments. The environment includes an electronic client device, such as the web client 610, which can include any appropriate device operable to send and/or receive requests, messages, or information over an appropriate network 674 and, in some embodiments, convey information back to a user of the device. Examples of such client devices include personal computers, cell phones, laptop computers, tablet computers, embedded computer systems, electronic book readers, smart devices, and the like. In this example, the network includes the Internet, ad-hoc networks, mesh-networks, or other decentralized communication solutions, as the environment includes a web server 676 for receiving requests and serving content in response thereto and at least one application server 677. It should be understood that there could be several distributed application servers. Servers, as used herein, may be implemented in various ways, such as hardware devices or virtual computer systems. In some contexts, servers may refer to a programming module being executed on a computer system. The example further illustrate a database server 680 in communication with a data server 678, which may include or accept and respond to database queries.

It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read only memory (CD-ROM), and so forth. In operation, a general purpose or application-specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the invention.

The foregoing examples illustrate certain example embodiments of the invention from which other embodiments, variations, and modifications will be apparent to those skilled in the art. The invention should therefore not be limited to the particular embodiments discussed above, but rather is defined by the claims.

While this invention has been particularly shown and described with references to example embodiments thereof, it will be understood by those skilled in the art that various changes in form and details may be made therein without departing from the scope of the invention encompassed by the appended claims.

Various embodiments of the present disclosure utilize at least one network that would be familiar to those skilled in the art for supporting communications using any of a variety of commercially-available protocols, such as Transmission Control Protocol/Internet Protocol (“TCP/IP”), protocols operating in various layers of the Open System Interconnection (“OSI”) model, File Transfer Protocol (“FTP”), Universal Plug and Play (“UpnP”), Network File System (“NFS”), Common Internet File System (“CIFS”), AppleTalk, UDP, WiFi, Bluetooth, infrared, ad-hoc networks, mesh-networks, or others. The network can, for example, be a local area network, a wide-area network, a virtual private network, the Internet, an intranet, an extranet, a public switched telephone network, an infrared network, a wireless network, a peer-to-peer (p2p) network or system, an ad hoc network, and any combination thereof.

In embodiments utilizing a web server, the web server can run any of a variety of server or mid-tier applications, including Hypertext Transfer Protocol (“HTTP”) servers, FTP servers, Common Gateway Interface (“CGI”) servers, data servers, Java servers and business application servers. The server(s) also may be capable of executing programs or scripts in response to requests from user devices, such as by executing one or more web applications that may be implemented as one or more scripts or programs written in any programming language, such as Java®, C, C# or C++, or any scripting language, such as Perl, Python or TCL, as well as combinations thereof. The server(s) may also include database servers, including, without limitation, those commercially available from Oracle®, Microsoft®, Sybase® and IBM®.

Alternative embodiments can be based on a peer-to-peer information storage and exchange system rather than storage and communication protocols in a client-server system.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members used in the above conjunctive phrase, “at least one of A, B, and C” and “at least one of A, B and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C to each be present.

Operations of processes described herein can be performed in any suitable order unless otherwise indicated herein or otherwise clearly contradicted by context. Processes described herein (or variations and/or combinations thereof) may be performed under the control of one or more computational systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

What is claimed is:

1. A computer-implemented method, comprising:
under the control of one or more computer systems configured with executable instructions,
decreasing occurrences of systemic instabilities, failures, and/or conflicts, the decreasing of the occurrences includes encouraging, modifying, or avoiding interactions between or among system components based, at least in part, on a type of situation;
reducing missed opportunities and/or lossful interactions; and
supporting systemically favorable kinds of interactions and/or supporting value exchange.

2. The computer-implemented method of claim 1, wherein the type of situation is a win-win situation, a good win-lose situation, a bad win-lose situation, and/or a lose-lose situation.

3. The computer-implemented method of claim 1, wherein a third-party broker is used for supporting the systemically favorable kinds of interactions.

4. The computer-implemented method of claim 1, wherein decreasing occurrences of systemic instabilities, failures, and/or conflicts further includes determining expected behaviors and social norms according to averages of the social behaviors over actual measured behaviors.

5. A system for providing recommendation and/or reputation information, the system comprising:
one or more processors; and
memory including instructions that, when executed by the one or more processors, cause the system to:
enable personally configurable and socially sharable information filters to be used to determine reputation values and recommendations;
employ several reputation criteria;
allow anonymous, pseudonymous and personalized ratings, enabled to be configured and determined in different manners;
classify different kinds of information according to various categories, enabled to be weighted differently; and
provide the reputation values to users.

6. The system of claim 5, wherein providing the reputation values to the users further includes providing ratings received from a community of users.

7. The system of claim 5, wherein the reputation system distinguishes different classes of information such as facts, opinions, or advertisements.

8. A computer-implemented method, comprising:
under the control of one or more computer systems configured with executable instructions,
aligning value changes of a system and at least one component of the system according to a respective valuation of interactions and/or potential interactions; and
exchanging related information in order to increase benefits of the system and the at least one component of the system and decrease instabilities and/or failures of the system and the at least one component of the system, wherein exchanging related information includes protecting sensitive data and
promoting responsible interactions such that favorable interactions are performed, unfavorable interactions are avoided, and/or semi-favorable interactions are improved or favorable interactions are made fairer, according to a bargaining and value exchange.

9. The computer-implemented method of claim 8, wherein promoting the responsible interactions includes using a reputation system or a way of creating transparency and feedback.

10. The computer-implemented method of claim 8, wherein one or several information brokers are employed, at least in part, to process the sensitive data.

11. The computer-implemented method of claim 8, further comprising determining reputation values and recommendations according to socially-sharable information filters, the socially-sharable information filters being personally configurable by a user or automatically-configurable according to a context.

12. A computer-implemented method for promoting participatory value or information exchange, comprising:
under the control of one or more computer systems configured with executable instructions,
promoting responsible exchange by at least partial transparency of transactions;
distinguishing different categories of money in order to encourage consumption or real investments or other desired effects such as feedback-based self-organization, wherein the different categories can include cash, real electronic money, virtual electronic money and/or multi-dimensional money; and
introducing at least one exchange fee and/or at least one tax for converting the different categories of money.

13. The computer-implemented method of claim 12, wherein the different categories of money include Reputation Money, wherein the Reputation Money includes a quantity of money and at least one quality, the at least one quality configured to (co-)determine a value of the Reputation Money by combining electronic money with a reputation system.

14. A computer-implemented method for measurement and estimation procedures based on sensors or sensor networks to quantify contexts, comprising:
under the control of one or more computer systems configured with executable instructions,
receiving feedback data, including actual measured behaviors;
determining expected behaviors or norms according to averages of behaviors over measured actual behaviors;
inferring desired and/or ideal behaviors based on valuations;
determining local cultures as sets of local norms by contrasting with local norms in different contexts; and
providing measurement information as feedback.

15. The computer-implemented method of claim 14, wherein the instructions further comprise instructions that, when executed by the one or more processors, cause the computer system to align individual and systemic benefits based on the provided measurement information.
